(19) United States
(12) Patent Application Publication
(10) Pub. No.: US 2022/0090978 A1
(43) Pub. Date: Mar. 24, 2022

(54) MEMBRANE ASSEMBLIES WITH SEALING FAULT DETECTION AND LOCATION, AND RELATED METHODS

(71) Applicant: HUMIGAL LTD., Jerusalem (IL)

(72) Inventor: Pinchas GOLDSTEIN, Jerusalem (IL)

(21) Appl. No.: 17/417,902

(22) PCT Filed: Dec. 25, 2019
(86) PCT No.: PCT/IB2019/061362

§ 371 Date: Jun. 24, 2021

Related U.S. Application Data
(60) Provisional application No. 62/785,255, filed on Dec. 27, 2018.

(30) Foreign Application Priority Data
Jul. 29, 2019 (GB) 1910766.3

(51) Int. Cl. G01M 3/16; E04B 1/66; G01M 3/04

(52) U.S. Cl. CPC G01M 3/16; G01M 3/045; E04B 1/665

(57) ABSTRACT

A water-impermeable membrane assembly, having leak alarm capabilities and useful for sealing a roof surface, comprises upper and lower water-impermeable membranes sealed to each other at respective perimeters to form a plenum enclosed from above and below with area defined by the perimeter sealing, a leak-alarm circuit within the plenum, activatable by the presence of water, a leak-alarm target in the circuit being operative to trigger activation of the leak-alarm circuit when in contact with water, and a capillary pathway disposed within the plenum in contact with the leak-alarm target, to provide a pathway for transport of water by capillary action to the leak-alarm target. The leak-alarm circuit comprises a transmitter for transmitting a signal when activated, and a battery for powering the transmission of the signal. A ratio of leak-alarm target footprint to plenum area is less than 0.05.

### CROSS-REFERENCE TO RELATED APPLICATIONS

This invention claims priority from U.S. provisional application Ser. No. 62/785255, filed on Dec. 27, 2018, which is incorporated by reference for all purposes as if fully set forth herein.

### FIELD OF THE INVENTION

The present invention relates to membrane assemblies for sealing structural substrates against the entrance of water, including membrane assemblies comprising integral water detection elements, and related components and methods for their manufacture and use in detecting and locating sealing faults within and around the membrane assemblies.

### BACKGROUND

The use of water-impenetrable membranes as sealing sheets for rooves and other structural substrates is well known in the industry. Such sealing sheets can include, for example, bitumen, polymers or other water-rejecting materials such as silicone-based materials.

Timely detection of manufacturing and installation defects in the sealing sheets, or of faults after extended time in situ, can save substantial costs of remediating water damage to structures and contents. The use of battery-powered and mains-powered circuits to detect water under sealing sheets is known in the industry, but such use depends upon depending on the water pooling at or near the detector before it has a chance to enter the substrate and begin to do damage. The inventor has discerned, however, that such detection circuits do not allow for simple and effective non-destructive testing to ensure the working status of components, or for quick identification and location of potential leaks. The inventor has further discerned that the products known in the industry require a more sophisticated and complex installation procedure and, in some cases, the hiring of different categories of workers other than semi-skilled sealing-sheet installers. Therefore, there is a need for water-impenetrable membranes with integral or built-in water detection capabilities, which afford simple installation and in-situ monitoring during their lifetimes.

### SUMMARY

Embodiments relate to water-impermeable membrane assemblies that include water-detection or leak-detection circuits and components, and methods for their manufacture and use.

According to embodiments, a water-impermeable membrane assembly for sealing a roof surface has leak alarm capabilities and comprises: (a) upper and lower water-impermeable membranes sealed to each other at their respective perimeters, so as to form a plenum that is enclosed from above and below by said membranes and that has an area defined on all of its sides by the sealing at said perimeters; (b) a leak-alarm circuit disposed within the plenum and activatable by the presence of a water-containing liquid, the leak alarm circuit having a leak-alarm target operative to trigger activation of the leak-alarm circuit when in contact with a water-containing liquid, the leak-alarm circuit comprising: (i) an electronic circuit comprising a transmitter, the electronic circuit being operative, when in an activated state triggered by said leak-alarm target, to transmit a signal, and (ii) a battery connected to the electronic circuit for powering transmission of said signal; and (c) a capillary pathway disposed within the plenum and in contact with said leak-alarm target, so as to provide a pathway for transport of a water-containing liquid by capillary action to said leak-alarm target, wherein a ratio of leak-alarm target footprint to plenum area is less than 0.15. In some embodiments, a ratio of leak-alarm target footprint to plenum area can be less than 0.1. In some embodiments, a ratio of leak-alarm target footprint to plenum area can be less than 0.05. In some embodiments, a ratio of leak-alarm target footprint to plenum area can be less than 0.025. In some embodiments, a ratio of leak-alarm target footprint to plenum area can be less than 0.01.

In some embodiments, a ratio of aggregate capillary pathway footprint to plenum area can be at least 0.3. In some embodiments, the ratio can be at least 0.5. In some embodiments, the ratio can be at least 0.7. In some embodiments, the ratio can be at least 0.9.

In some embodiments, the plenum may be virtually divided into 100 equal-area subdivisions, and a continuous capillary pathway exists to said leak-alarm target from at least 50% of said equal-area subdivisions. In some embodiments, a continuous capillary pathway can exist to said leak-alarm target from at least 70% of said equal-area subdivisions. In some embodiments, a continuous capillary pathway can exist to said leak-alarm target from at least 90% of said equal-area subdivisions. In some embodiments, a continuous capillary pathway can exist to said leak-alarm target from at least 30% of said equal-area subdivisions.

In some embodiments, it can be that the leak-alarm target is the battery and the battery is a water-activated battery. In some such embodiments, a first portion of said capillary pathway can be engaged with two electrodes of the water-activated battery, such that in the presence of water in said first portion sufficient to contact both of the two electrodes, a current-generating reaction takes place in the water-activated battery. In some such embodiments, the assembly can additionally comprise a salt disposed at a second portion of the capillary pathway that is not the first portion, wherein the current-generating reaction is facilitated by salt dissolved in the water-containing liquid and conveyed to the battery by said transport.

In some embodiments, it can be that the electronic circuit comprises a water-detection circuit, and the leak-alarm target is the water-detection circuit.

In some embodiments, the leak-alarm circuit can be configured to transmit information related to its status in response to being polled.

In some embodiments, the leak-alarm circuit can be configured to transmit information about the identity and/or location of the assembly in response to being polled.

In some embodiments, the transmitted signal can include information about the identity and/or location of the assembly.

In some embodiments, the assembly can additionally comprise a plurality of capillary-pathway extensions, said extensions passing through slits in the lower water-impermeable membrane and in contact with said in-plenum capillary pathway, so as to provide a pathway for transport of a water-containing liquid by capillary action from outside the plenum and below the lower water-impermeable membrane, to said leak-alarm target inside the plenum.

In some embodiments, the capillary pathway can comprise at least one of a plant-based fiber, a polymer-based fiber, a glass fiber and a carbon fiber.

In some embodiments, it can be that the area of the plenum is at least 0.6 square meters. In some embodiments, it can be the area of the plenum is at least 0.8 square meters.

In some embodiments, the upper and lower water-impermeable membranes can be bonded to each other at a plurality of points within the plenum.

In some embodiments, it can be that at least one membrane of the upper and lower water-impermeable membranes is characterized by grooves and/or channels in a respective plenum-facing surface, and the capillary pathway is disposed in at least some of said grooves and/or channels.

According to embodiments, a super-assembly can comprise a plurality of water-impermeable membrane assemblies according to any of the embodiments disclosed herein, the assemblies being arranged in a continuous strip.

A method is disclosed, according to embodiments, for sealing a substrate using a plurality of leak-detecting membrane assemblies. The method comprises bonding, to the substrate, a plurality of water-impermeable membrane assemblies in accordance with any of the embodiments disclosed herein, each assembly comprising: (i) upper and lower water-impermeable membranes sealed to each other at their respective perimeters, so as to form a plenum that is enclosed from above and below by said membranes and that has an area defined on all of its sides by the sealing at said perimeters; (ii) a leak-alarm circuit disposed within the plenum and activatable by the presence of a water-containing liquid, the leak alarm circuit having a leak-alarm target operative to trigger activation of the leak-alarm circuit when in contact with a water-containing liquid, said leak-alarm target having a footprint equal to less than 5% of the area of the plenum, the leak-alarm circuit comprising (A) an electronic circuit comprising a transmitter, the electronic circuit being operative, when in an activated state triggered by said leak-alarm target, to transmit a signal, and (B) a battery connected to the electronic circuit for powering transmission of said signal; and (iii) a capillary pathway disposed within the plenum and in contact with said leak-alarm target, so as to provide a pathway for transport of a water-containing liquid by capillary action to said leak-alarm target.

In some embodiments, the method can additionally comprise, before said bonding, applying a primer to said substrate.

In some embodiments, the method can additionally comprise, after said bonding: polling said leak-alarm circuit and, in response to said polling, receiving information transmitted by said leak-alarm circuit, the information being related to a status of said leak-alarm circuit.

A method is disclosed, according to embodiments, for manufacturing a water-impermeable membrane assembly. The method comprises: (a) installing, on a first water-impermeable membrane, a leak-alarm circuit, the leak-alarm circuit being activatable by the presence of a water-containing liquid and having a leak-alarm target operable to trigger activation of the leak-alarm circuit, said leak-alarm target having a footprint equal to less than 5% of the area of the plenum, the leak-alarm circuit comprising: (i) an electronic circuit comprising a transmitter, the electronic circuit being operative, when in an activated state triggered by said leak-alarm target in response to being in contact with a water-containing liquid, to transmit a signal, and (ii) a battery connected to the electronic circuit for powering transmission of said signal; (b) further installing, on said first water-impermeable membrane, a capillary pathway, such that a portion of the capillary pathway is in contact with said leak-alarm target so as to provide a pathway for transport of a water-containing liquid by capillary action to said leak-alarm target; and (c) sealing a second water-impermeable membrane to said first water-impermeable membrane at least at their respective perimeters, so as to form a plenum enclosed from above and below by said first and second membranes, the plenum having an area defined on all sides by the sealing at said perimeter, wherein after said sealing, said leak-alarm circuit and said capillary pathway are disposed within said plenum.

### BRIEF DESCRIPTION OF THE DRAWINGS

The invention will now be described further, by way of example, with reference to the accompanying drawings, in which the dimensions of components and features shown in the figures are chosen for convenience and clarity of presentation and are not necessarily to scale. In the drawings:

FIGS. 1A and 1B are perspective-view schematic drawings, respectively assembled and in exploded view, a water-impermeable membrane assembly comprising a leak-alarm circuit and a capillary pathway according to embodiments of the present invention.

FIG. 1C is a schematic partial cross section of a membrane assembly having an extension of the capillary pathway through the bottom membrane of the assembly, according to embodiments of the present invention.

FIG. 2 is a perspective-view schematic drawing of a lower membrane with capillary pathway having removed sections to enable, inter alia, additional sealing points of the upper and lower membranes to each other, according to embodiments of the present invention.

FIG. 3 is a block diagram of a leak-alarm circuit, according to according to embodiments of the present invention.

FIGS. 4A and 4B are perspective-view schematic drawings of lower membranes with respective capillary pathway in various configurations, according to embodiments of the present invention.

FIG. 5A is a perspective-view schematic drawing of a lower membrane with respective capillary pathway, with an equal-area distribution grid superimposed thereupon, according to embodiments of the present invention.

FIGS. 5B and 5C are, respectively, a perspective-view schematic drawing and a detail thereof, of a lower membrane with respective capillary pathway provided in grooves formed in the surface of the lower membrane, with an equal-area distribution grid superimposed thereupon, according to embodiments of the present invention.

FIG. 5D shows a schematic cross-section of a groove of FIG. 5B or 5C, according to embodiments of the present invention.

FIG. 6A shows a continuous strip of lower membranes with respective capillary pathways and leak-alarm circuits, according to embodiments of the present invention.

FIGS. 6B and 6C show a super-assembly of water-impermeable membrane assemblies as, respectively, a continuous strip of membrane assemblies and a continuous roll of membrane assemblies, according to embodiments of the present invention.

FIG. 7A is a block diagram of a leak-alarm circuit where the leak-alarm target comprises a water-activated battery, according to embodiments of the present invention.

FIG. 7B is a partial schematic cross-sectional view of components of a water-activated battery in a membrane assembly, according to embodiments of the present invention.

FIG. 7C is a schematic perspective-view drawing of components of a water-activated battery in a membrane assembly, according to embodiments of the present invention.

FIG. 8 is a block diagram of a leak-alarm circuit where the leak-alarm target comprises a water-activated circuit, according to embodiments of the present invention.

FIGS. 9 and 10 show flowcharts of respective methods for using and fabricating water-impermeable membrane assemblies, according to embodiments of the present invention.

FIGS. 11 and 12 are block diagrams of autonomous detection transmission monitoring units according to embodiments of the present invention.

FIG. 13 is a schematic cross-sectional view of components of a water-activated battery according to embodiments of the present invention.

FIG. 14 is a block diagram showing an example of an electrical circuit according to embodiments of the present invention.

FIG. 15 is a plan view of an autonomous detection transmission monitoring unit imbedded within in a segment of a bitumen smart sealing sheet, according to embodiments of the present invention.

FIG. 16 is a schematic perspective-view drawing of autonomous detection transmission monitoring units imbedded within respective segments of membrane assemblies assembled in a continuous strip, according to embodiments of the present invention.

FIG. 17 is a schematic cross-sectional view of an autonomous detection transmission monitoring units sealed into a membrane assembly according to embodiments of the present invention.

FIG. 18 is a top of view of an autonomous detection transmission monitoring unit in a membrane segment according to embodiments of the present invention.

FIG. 19 is a block diagram showing an example of an electrical circuit according to embodiments of the present invention.

FIG. 20 is a block diagram of a membrane assembly being tested with a portable testing device according to embodiments of the present invention.

FIG. 21 is a block diagram showing an example of an electrical circuit according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements. Subscripted reference numbers e.g., 10₁ or letter-modified reference numbers e.g., 100a are used to designate multiple separate appearances of elements in a single drawing, e.g. 10₁ is a single appearance out of a plurality of appearances of element 10, and 100a is a single appearance out of a plurality of appearances of element 100.

According to embodiments, a water-impermeable membrane assembly includes two water-impermeable membranes sealed to each other, at least at their edges. The double-membrane sheet can be produced in a continuous strip of membrane assemblies for easier and more efficient installation on a substrate such as a roof, a floor or a wall. Apparatus for detecting a leak, i.e., the presence of water or the presence of a water-containing liquid, can be included between the two membranes. The apparatus can include a leak-alarm circuit having a leak-alarm target, along with a material, generally fiber-containing, deployed so as to facilitate transport of the water-containing liquid from anywhere in the plenum created by the sealing of the two membranes to each other, to the leak-alarm target. The transport can be by capillary action. A “leak-alarm circuit” is an assembly of a battery and electronic components; when the leak-alarm circuit is activated in the presence of water, a signal is transmitted. Such a signal can include information, can include an alarm, or can simply be interpreted as an alarm by the mere fact that it has been transmitted. A “leak-alarm target” is that part of the leak-alarm circuit to which water has to be transported in order to trigger the activation of the leak-alarm circuit.

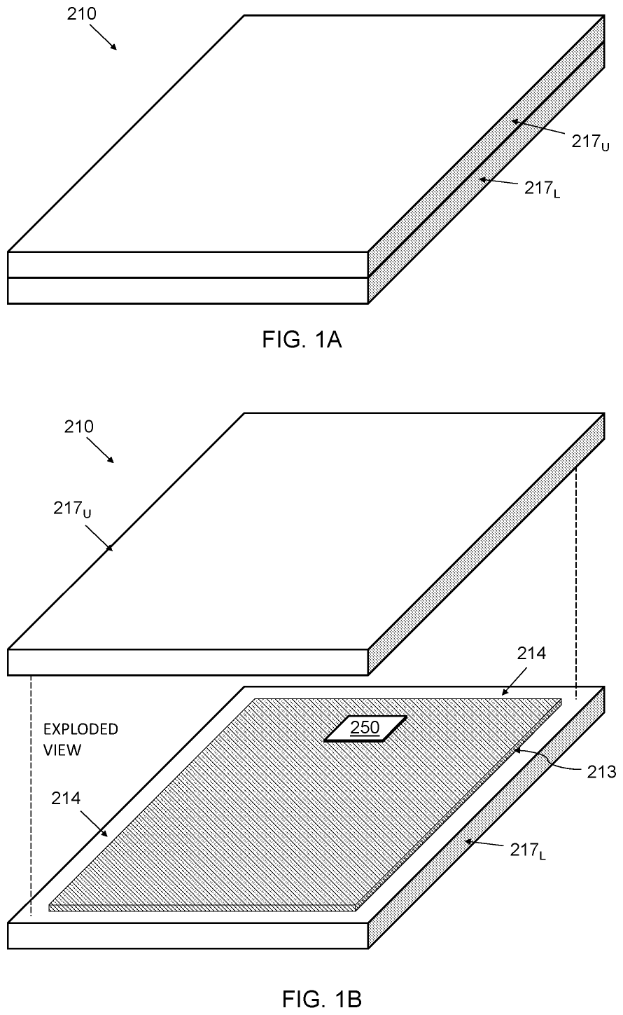

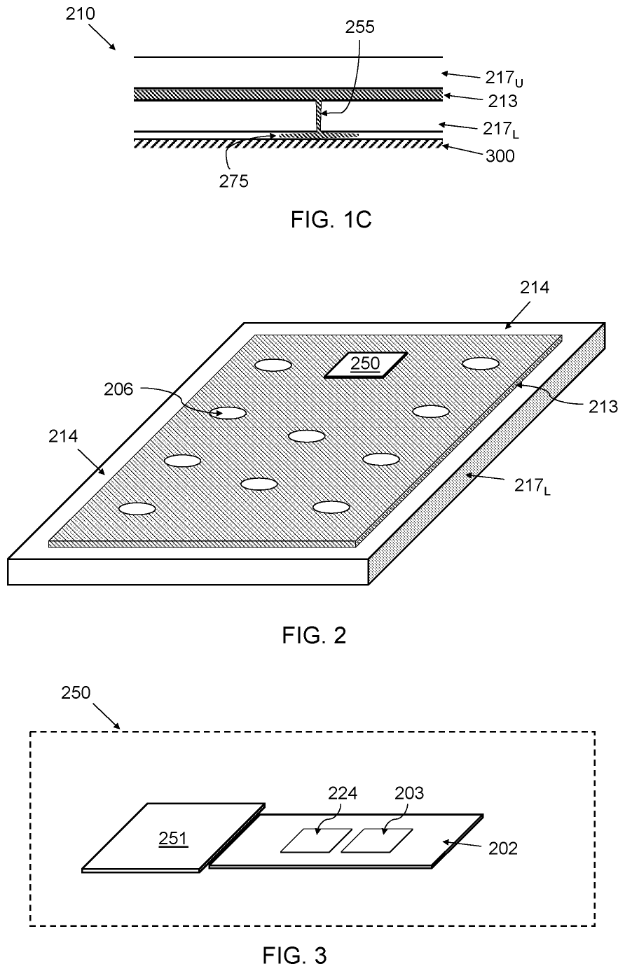

Referring now to FIGS. 1A and 1B, a membrane assembly 210 is illustrated in assembled FIG. 1A and exploded views FIG. 1B. Two membranes 217 comprising respective upper and lower membranes 217_{U}, 217_{L} are sealed to each other around perimeter 214 to form a membrane assembly 210. It should be noted that ‘upper’ and ‘lower’ conventions are used only for convenience and illustration. For example, a membrane 217 that is an upper membrane 217_{U} at the time of manufacture and/or assembly might be a lower membrane 217_{L} at the time of in situ installation. As another illustrative example, if the assembly process includes reel-to-reel processing, there may not be an ‘upper’ or ‘lower’ membrane, but rather two membranes arranged in continuous sheets of many membranes facing each other in whatever position or attitude is suitable for the process. The sealing of two membranes 217 to each other can include any appropriate sealing technology that renders the sealed edges water-impermeable, such as heat sealing, ultrasonic welding, adhesion with or without an additional material interposed between respective edges 214 of facing membranes, and the like. The sealing of the two membranes 217 to each other can create a space, or plenum, between them.

Membranes 217 can include water-impermeable sheets of any size or thickness, fabricated from any water-impermeable material of suitable durability and cost. In some embodiments, membranes can comprise bitumen. In other embodiments, membranes can comprise a polymer such as PVC polyvinyl chloride. In yet other embodiments, membranes can comprise a silicone-based material. The size of the membranes can be selected in accordance with the specifications of manufacturing or assembly systems, or in accordance with installation procedures. It can be desirable for the membrane to be considerably larger than a leak-alarm target so as to maximize the area covered by each leak-alarm circuit. In some embodiments, a membrane and the resulting membrane assembly comprising two similarly sized membranes can have an area of at least 0.25 sqm (square meters), at least 0.5 sqm, at least 0.75 sqm, at least 1.0 sqm, at least 1.5 sqm, at least 2 sqm, or larger. The membranes and membrane assemblies illustrated herein show an aspect ratio that ranges from square to 2:1, but this is not of importance and the membrane assemblies can have any suitable aspect ratio.

According to exemplary embodiments, fabrication of a membrane assembly 210 can include the installation of a capillary pathway 213 which, after assembly, occupies all or part of the area of the plenum, as illustrated in FIG. 1B. The area of the plenum is defined by sealed lateral edges 214. A “capillary pathway” is a material suitable for transport of water along a pathway by capillary action. Such a material often includes fibers, such as plant-based fibers e.g., cellulose, polymer-based fibers e.g., polyester, glass fibers e.g., in a woven fabric or even as bundles of glass fibers, or carbon fibers. In some non-limiting examples, the fibers can be very small, i.e., having diameters in the range of several or tens of microns. While the term “pathway” may appear to imply that a pathway for water transport to a leak-alarm target may be a direct path, that is not necessarily the case. The transport of water through the capillary pathway may include progression in random directions or omnidirectional progression. In some embodiments, the capillary pathway 213 can include fibers arranged so as to form direct pathways from various parts of the plenum between the upper and lower membranes 217_{U}, 217_{L} but this is not necessary for the capillary transport to be effective. The key in deploying the capillary pathway is to ensure a substantially continuous pathway for the capillary transport regardless of either the direct nature of the transport or the fact that the water may be ‘spread’ in all directions throughout the capillary pathway material before reaching the leak-alarm target. In some embodiments, the capillary pathway can comprise a hydrophilic material that is effective to facilitate transport of water.

Fabrication of a membrane assembly 210 can also include the installation of a leak-alarm circuit 250 as illustrated in FIG. 1B.

Installation of either or both of the capillary pathway 213 and the leak-alarm circuit 250 in the membrane assembly 210 can be accomplished using any attachment option such as an adhesive or a mechanical fastener, or alternatively by simply placing on a lower membrane 217_{L}. In a non-limiting example, a capillary pathway 213 may be placed upon the lower membrane 217_{L}, without any attachment therebetween, and the leak-alarm circuit 250 may be attached at least in part to the capillary pathway 213 using an adhesive or a mechanical fastener. The leak-alarm circuit 250 obviously can be placed anywhere on the lower membrane 217_{L}, and its positioning is not limited to examples shown in the figures.

In embodiments, a capillary pathway can be extended so as to provide capillary transport of water to the water-leak target from beneath the membrane. As illustrated schematically in FIG. 1C, a cross-section of membrane assembly 210 comprises upper and lower membranes 217_{U}, 217_{L}, with a capillary pathway 213 between them. An extension 275 of the capillary pathway 213 extends through slit 255 in the lower membrane 217_{L}, into the space between lower membrane 217_{L}, and substrate 300. The extension 275 obviously can be extended in any direction and to any extent.

We now refer to FIG. 2. In some embodiments, it can be desirable to seal membranes 217_{U} and 217_{L}, at additional points, i.e., not just on the lateral edges 214 and especially when the dimensions of the membranes 217 are very large e.g., at least 70 cm on a side, at least 80 cm on a side, at least 90 cm on a side, at least 100 cm on a side, or larger. In such embodiments there may be one or more sealing-openings 206 in the capillary pathway 213 so that the membranes 217_{U} and 217_{L} can be sealed to each other at some or all of those openings 206. Any number of openings 206 may be used; in various embodiments, their size, shape, distribution and spacing are determined by where the designer feels that additional sealing/attachment points between the two membranes 217 will be of value; in other embodiments they can be determined based on the manufacturing assembly process, or simply for convenience.

FIG. 3 illustrates, schematically, key components of a leak-alarm circuit 250. Leak-alarm target 251 comprises the water-activated trigger for activating the leak-alarm circuit 250 in the presence of a water-containing liquid. The leak-alarm circuit 250 also comprises electronic circuit 202, a transmitter 224 and an antenna 203. According to embodiments, when leak-alarm target 251 is activated by the presence of water, transmitter 224 transmits a signal via antenna 203. A leak-alarm target 251 can have a very small footprint relative to the area of a capillary pathway 213 or to the total area of the plenum between the membranes 217. In examples, the area of the plenum can be at least 20 times larger than the footprint of the leak-alarm target 251 i.e., a footprint defined on the primary plane of the plenum. In some embodiments, the area of the plenum can be at least 40 times larger than the footprint of the leak-alarm target 251. In some embodiments, the area of the plenum can be at least 100 times larger than the footprint of the leak-alarm target 251.

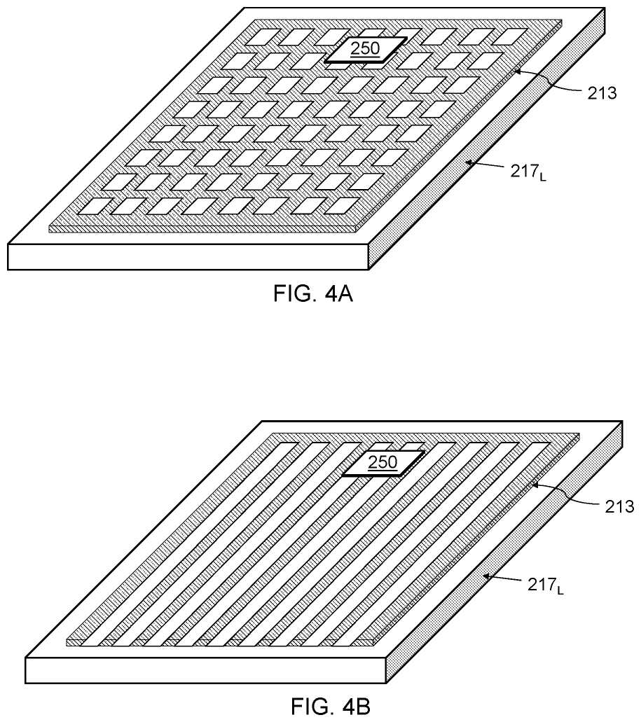

Referring now to FIG. 4A, a capillary pathway 213 according to embodiments is formed as a lattice comprising strips of a material. According to embodiments, the material contains fibers for facilitating capillary action. It can be seen that there is a continuous capillary pathway from every point on the lattice of capillary pathway material to the leak-alarm target 251 not shown in FIG. 4 of the leak-alarm circuit 250. It is preferable to use an inexpensive material for capillary pathway 213, but in some cases it can be desirable to save on material by reducing the aggregate footprint of the capillary pathway 213. Another example, illustrated in FIG. 4B, shows a capillary pathway 213 comprising a plurality of strips. Since the strips are at least indirectly in contact with each other via the cross-strip at one end, there is still a continuous pathway for capillary transport from any point on the strips to the leak-alarm target. As illustrated a ‘continuous’ pathway means without interruption, and not necessarily a linear path or an optimized shortest path. The option of strips can be implemented using any of the fiber-containing materials discussed hereinabove. In an example, bundles of tens of glass fibers each, where each strip has a width in the range of less than a millimeter to several centimeters, can be aligned so as to provide continuous capillary transport to the leak-alarm target. It can be desirable to have the capillary pathway 213 fill a large proportion of the area of the plenum created by the lateral-edge sealing of the two membranes 217. In embodiments, the aggregate footprint of the capillary pathway 213 can cover at least 30% of the area of the plenum between the membranes 217; in other embodiments, the aggregate footprint can be at least 50%, at least 70%, or at least 90% of the area of the plenum.

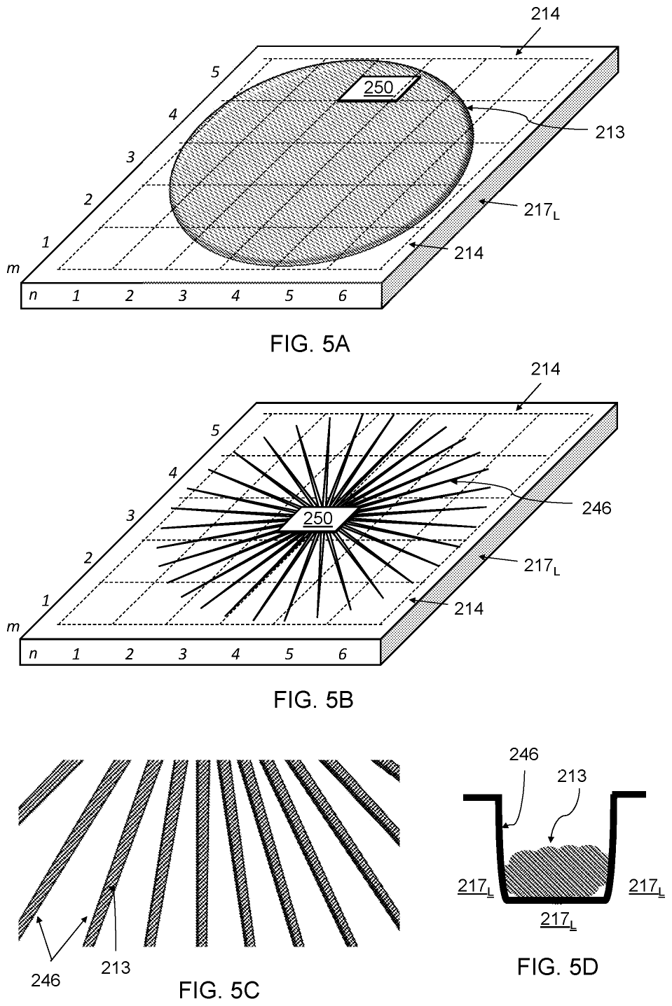

In embodiments, it can be desirable to ensure continuity of a capillary transport pathway to a leak-alarm target throughout the plenum of a membrane assembly. In other words, it may be desirable—regardless of whether the capillary pathway has a high aggregate footprint relative to the area of the plenum—to ensure a wide distribution of capillary pathway material throughout the plenum. Referring now to FIG. 5A, a lower membrane 217_{L}, is shown with a capillary pathway 213 having a curved shape that clearly does not reach all the corners of the inter-membrane plenum. Obviously, this example is meant to be illustrative and there is no importance in whether the shape is curved or rectilinear, convex or concave, etc. Superimposed on the figure is a grid of m×n equal-area subdivisions of the area of the plenum. In the illustrative example of FIG. 5A, m equals 5, n equals 6, and m×n equals 30. A careful examination of FIG. 5A reveals that 28 of the 30 equal-area subdivisions of the plenum have at least some of the capillary pathway 213 within their respective borders—and since there are no discontinuities in the capillary pathway 213, there is a continuous capillary pathway from at least a portion of each one of 28 out of 30 equal-area subdivisions of the plenum area to a water-leak target within the footprint of the water-leak alarm circuit 250. A grid of any resolution can be applied for assessing the distribution of the capillary pathway 213. In some embodiments, m×n can be equal to at least 30, at least 50, or at least 100. The proportion of equal-area subdivisions from which there is a continuous capillary pathway to the leak-alarm target 251 can be at least 50% of the total equal-area subdivisions of the plenum area, at least 70% of the total equal-area subdivisions of the plenum area, or at least 90% of the total equal-area subdivisions of the plenum area as illustrated in FIG. 5A.

A second illustrative example of providing pathways for continuous capillary transport is shown in FIG. 5B. FIG. 5B is similar to FIG. 5A, except that instead of a mat of capillary transport material 213, a plurality of grooves 246 is provided in lower membrane 217_{L}, and capillary pathway material 213 is provided within the grooves 246. Here, too, in 28 out of the m×n=30 equal-area subdivisions there is a continuous capillary transport pathway to the leak-alarm target 251 within illustrated leak-alarm circuit 250. FIG. 5C shows a detail of grooves 246 with capillary pathway material 213 from FIG. 5A, and FIG. D is a cross-section of an exemplary groove 246. The pattern, distribution and cross-sectional shape of the grooves in FIG. 5D are for purposes of illustration and do not in any way limit the design options available. In an alternative embodiment (not shown), capillary transport material 213 can be deployed in the pattern of FIG. 5B without the use of grooves.

Use of the “minimum footprint ratio of aggregate capillary pathway 213 to plenum area” metric can be combined in embodiments with the “minimum proportion of equal-area subdivisions of the plenum area” metric in order to ensure that there is continuous capillary transport both from as much capillary pathway 213 as necessary, in terms of both i total capillary area pathway and ii distribution throughout the plenum.

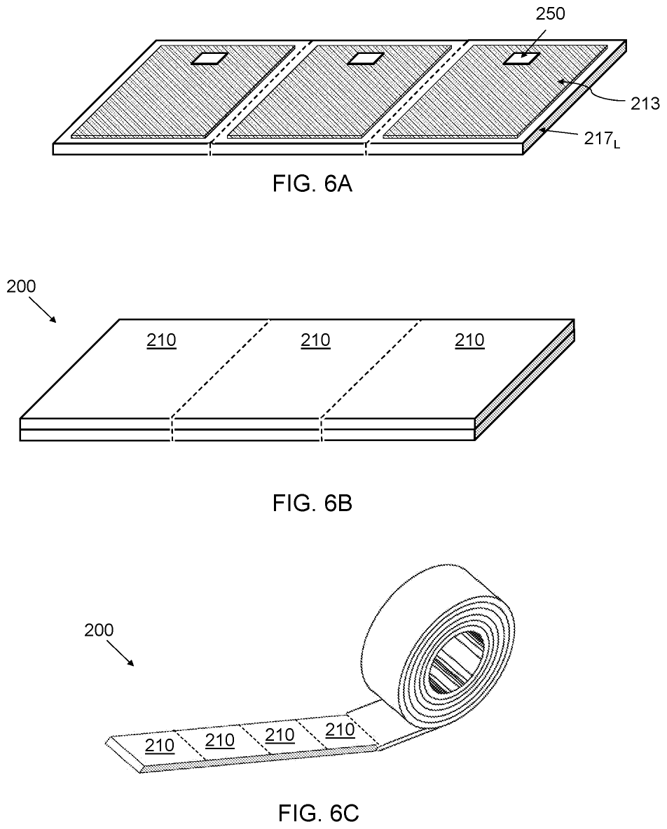

We now refer to FIGS. 6A, 6B and 6C. According to embodiments, a super-assembly 200 comprises a plurality of membrane assemblies 210 that are assembled in accordance with any of the embodiments disclosed herein. The individual membrane assemblies 210 can be fabricated in a continuous strip of membrane assemblies 210. An example of said fabrication includes installing a respective plurality of capillary pathways 213 and a respective plurality of leak-alarm targets 250 on a plurality of lower membranes 217_{L} so as to form the sub-assembly shown in FIG. 6A. Later in the fabrication process, a plurality of upper membranes 217_{U} is sealed to the subassembly at least along the respective perimeters of each of the membrane assemblies 210 in the super-assembly 200. The dashed lines in FIGS. 6A-6C represent the extent of each membrane/membrane assembly and are shown for illustration purposes only.

As illustrated in FIG. 6C, a super-assembly of membrane assemblies 210 may be rolled up for ease of storage, transport and/or installation.

### Examples of Water-Leak Alarms

A water-leak alarm can comprise any water-activated circuit configured to be triggered by the presence of water and thereupon transmit a signal.

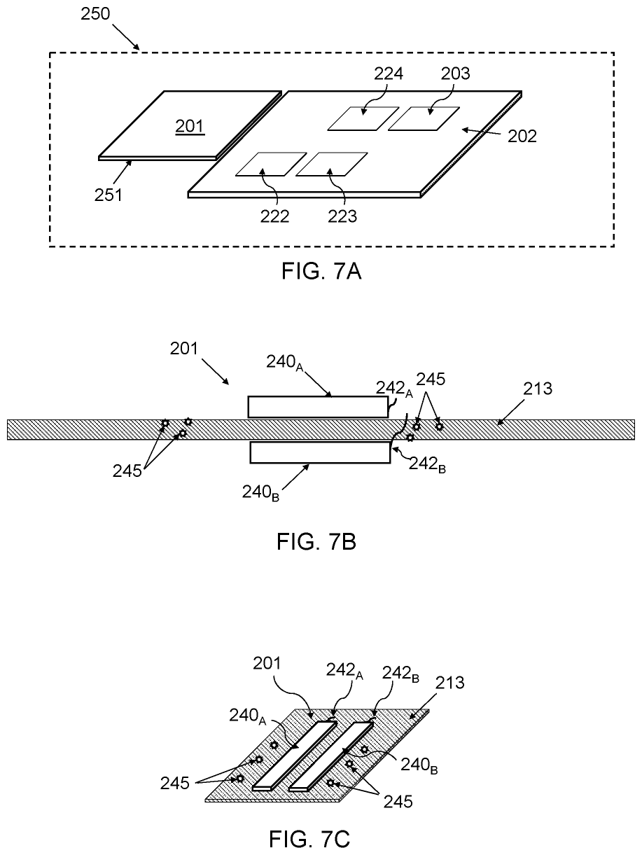

In a first example, illustrated schematically in FIG. 7A, leak-alarm target 251 comprises a water-activated battery 201. In this example, the leak-alarm circuit can additionally include a capacitor 222 for storing energy from the water-activated battery in case the voltage and/or power generated by the water is/are designed to be too low to directly power the transmitter 224. Energy can be stored by the capacitor 222 until released, for example, using a voltage-controlled solenoid switch 223.

A water-activated battery, as is known in the art, is built of two electrodes typically made from thin metal foils or meshes attached to current carrying leads and kept dry until a water-containing liquid is introduced between the electrodes so as to generate an electric current. Examples of materials that can be used as anodes are zinc, aluminum, magnesium, tin and alloys thereof. Examples of suitable cathode materials include copper or copper alloys, or nickel or stainless steel or titanium. In some cases, an anode can comprise a metallic substrate coated with electrochemically active metal—for example, galvanized steel or tin coated steel. If desired, higher cell voltages may be obtained using a cathode comprising manganese dioxide/carbon or cuprous chloride/carbon. In some embodiments, as shown in FIG. 7B, the capillary pathway 213 can serve as a separator between two electrodes 240. Respective electrical leads 242 of material(s) selected to avoid a galvanic reaction over time connect the electrodes 240 to a load (i.e., the leak-alarm circuit, not shown), including through the capillary pathway 213 if necessary. The capillary pathway 213 insulates the electrodes 240 from each other over time, preventing a short circuit, until water transported by the capillary pathway 213 reaches the electrodes 240, e.g., from a leak in the membrane assembly 210. In other embodiments, as shown in FIG. 7C, both electrodes 240 can be installed on the same side of the capillary pathway 213 for greater ease of producing the membrane assembly 210. In both of the embodiments illustrated in FIGS. 7B and 7C, the footprint of the water-activated battery 201, i.e., of electrodes 240, can be a tiny fraction of the footprint of the capillary pathway 213 that also acts as a separator for the battery.

In some embodiments, a water-activated battery 201 requires a solution of a salt in the water-containing liquid for the liquid to act as an electrolyte. To this end, solid materials which, upon contact with water, dissolve to form ions, may be disposed within capillary material 213. Such materials may be neutral, alkaline, or acidic substances. Such solid materials may not be salts, for example, citric acid may be utilized. Non-limiting examples include ammonium chloride, sodium carbonate, citric acid, sodium chloride, and zinc chloride. Various sulfates may be used. The solubility of these solid materials in water at 25° C. may be at least 1 g/liter, and more typically, at least 10 g/liter or at least 50 g/liter. As shown in FIGS. 7B and 7C, a salt 245 can be distributed within the open structure of the capillary pathway 213. The salt 245 is preferably not distributed in the part of the capillary pathway 213 that is within the footprint of one or both electrodes 240 so as to prevent inadvertent activation during the storage life of the membrane assembly 210.

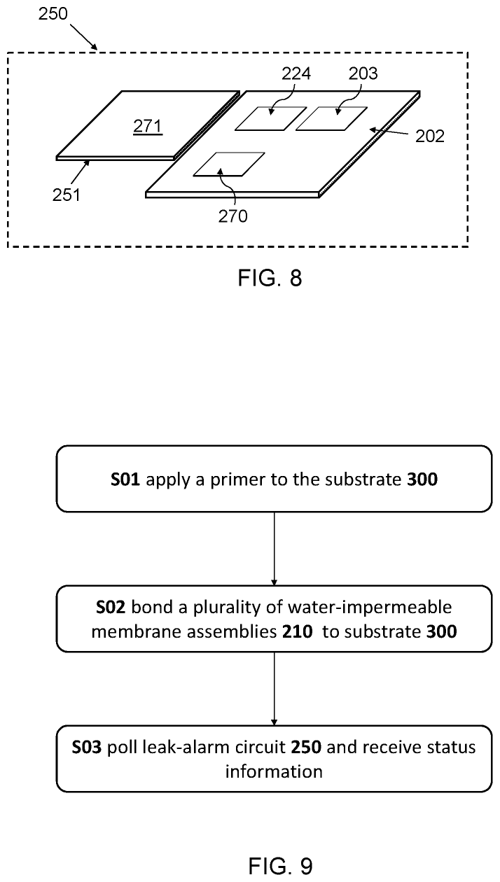

In a second example, illustrated schematically in FIG. 8, leak-alarm target 251 comprises a water-activated circuit 271. Water activated-circuits, as are known in the art, can be as simple as a pair of probe wires, a resistor, an NPN transistor, optionally a second resistor or potentiometer to protect the transistor, and a power supply. The power supply can be a small, long-life battery such as, for example, a coin cell. Illustrative examples of suitable water-activated circuits can be found, for example, in U.S. Pat. Nos. 4,297,686 and 6,683,535, the teachings of which are incorporated herein by reference, in their entirety. Any or all of the electrical components except for the probe wires or equivalent can be coated in a waterproof coating, e.g., an epoxy encapsulant, for protection.

Referring now to FIG. 9, a flowchart is shown of a method for sealing a substrate using a plurality of leak-detecting membrane assemblies. The method comprises:

Step S01 applying a primer to the substrate 300;

Step S02 bonding a plurality of water-impermeable membrane assemblies 210 to substrate 300; and

Step S03 polling the leak-alarm circuit 250 and receiving status information.

In some embodiments, not all of the steps of the method are performed.

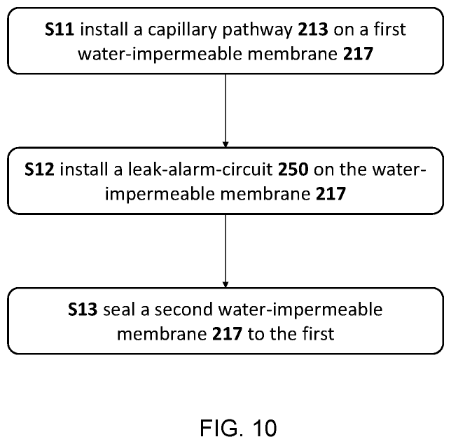

Referring to FIG. 10, a flowchart is shown of a method for manufacturing a water-impermeable membrane assembly. The method comprises:

Step S11 installing a capillary pathway 213 on a first water-impermeable membrane 217;

Step S12 installing a leak-alarm-circuit 250 on the water-impermeable membrane 217; and

Step S13 sealing a second water-impermeable membrane 217 to the first membrane 217.

Steps S11 and S12 may be performed in any order according to the design of the manufacturing process, and any such order of performance is within the scope of the invention.

### Additional Discussion

The present invention relates to a novel system for effective monitoring of breach in structural sealing that may cause leaks. It will send alerts about the fault, its severity, the time it occurred and its exact location.

Providing early detection and accurate location of the fault will prevent the leakage damages by allowing the rapid and precise local repair of the sealing and stop the leakage before the humidity penetrates the building and causes damages. This saves money, time and ongoing inconvenience involved when leakage penetrates the building and it takes time and money to find the defected area and usually the whole sealing has to be replaced.

Embodiments of the present invention enable the fast fix of the fault in a fraction of time and cost of repairing the conventional sealing, as it enables to pin point in “no time” the failure and replace only the defected small section in the sealing membrane, which ends up with only a small portion of the cost of replacing an entire roof section.

Any of the systems disclosed herein can be applied to existing building while renewing the conventional sealing and can be used to seal roofs, walls, etc., in new buildings and structures.

One way to apply the technologies embodied herein is by integrating said technologies into sealing sheets such as sealing sheets, e.g., bitumen sealing sheets, PVC sealing sheets, or silicone-based sealing sheets. The Smart Sealing Sheet or Smart Bitumen Sealing Sheet of the present invention contains sealed segments. Each sealed segment contains an Autonomous Detection-Transmission Monitoring Unit, which detects whenever water penetrates the segment and transmits the information about the fault and its location to the owner or the maintenance company. The Autonomous Detection Transmission Monitoring Unit, may not be active until a fault is created and water penetrates its segment. As water seeps in, it “wakes up” and begins sending at least one warning signal informing about the breach and its location.

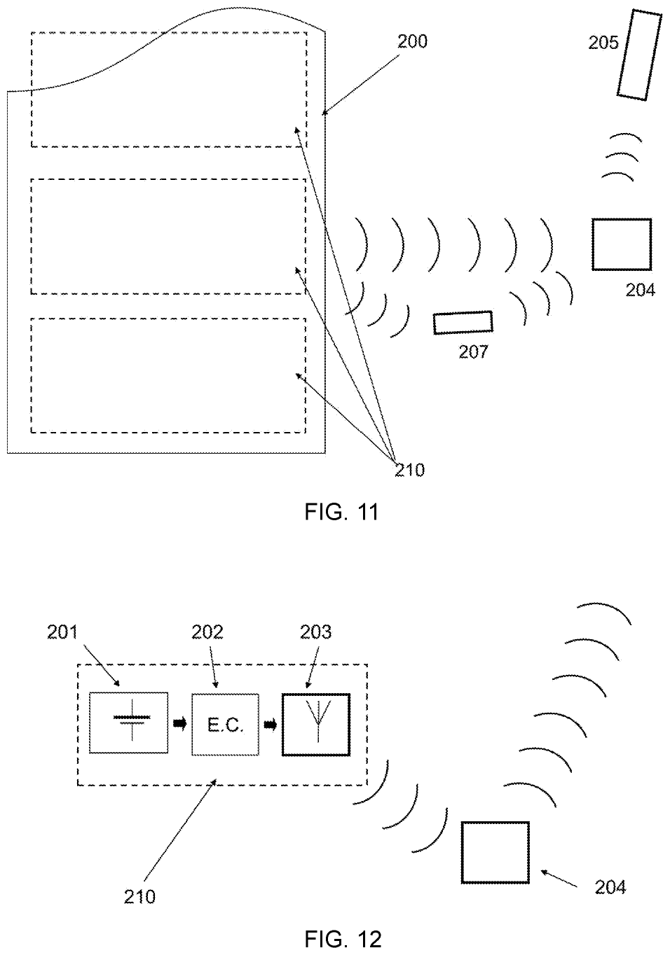

FIG. 11 is a block diagram of the system. It includes a Smart Sealing Sheet 200 divided into several sections 210. Each section is sealed from its neighbor sections, and each section contains an Autonomous Detection-Transmission Monitoring Unit “ADTMU”.

A Controller or Control Unit 204, is located within the transmission range of all the ADTMUs. When humidity penetrates one of the sections, its ADTMU is activated and sends a warning signal to the Control Unit 204. The Control Unit activates an alarm or broadcasts the alarm on the cellular, LAN or web network to a monitoring system 205. This monitoring system may include a smartphone, tablet, computer or any other device.

For large roof areas or roofs covered with vegetation tiles or earth, which may limit the range of transmission of the ADTMU 210 to the Control Unit 204 a transducer 207 can be used, for passing on the signal received from the ADTMU 210 and retransmit it to the Control Unit 204.

FIG. 12 is a block diagram of the ADTMU. The ADTMU 210 includes a “WAB” Water Activated Battery 201 which creates electricity only by the existence of water, therefore it will be activated only if following a fault, water penetrates the Smart Sealing Sheet. As soon as the battery is activated, it begins to supply power to the Electric Circuit “E.C.” 202, causing it to transmit a signal with an alert message. The E.C. uses the Antenna 203 for allowing the transmitted signal to reach the Control Unit “CU” 204.

As long as there is no fault in the sealing, the battery 201 is not active and does not produce any power, and the whole system is in its “dormant” state. Once, following a fault, water enters the sealing, the battery 201 is activated, and begins to emit electric current, causing the E.C. 202, to broadcast a signal to the CU204, informing it about the fault, its location and severity, which in turn activates the alarm and broadcasts it on the cellular, LAN, web network etc.

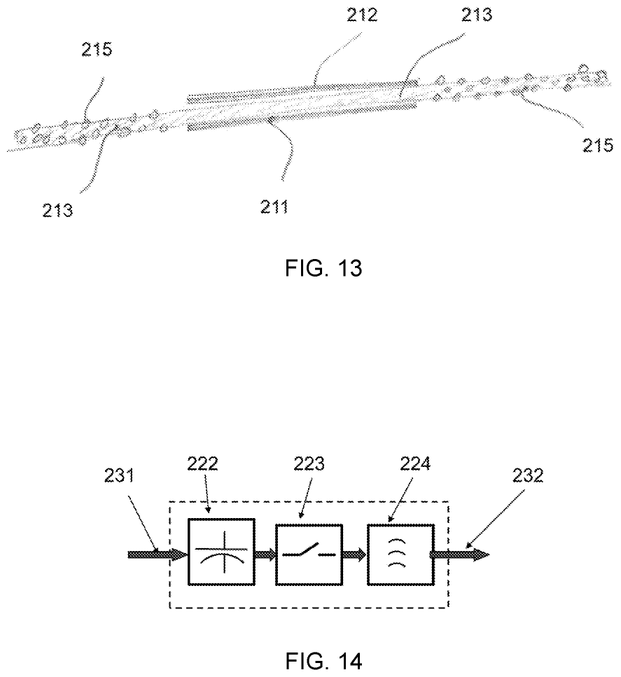

FIG. 13 is a Cross-section view of the Water Activated Battery. The water activated battery is built of two small electrodes, in the middle of the separator 213 located on its both sides opposite to each other. One is the anode 211 and the other the cathode 212. The electrodes can be made from thin metal foils or meshes attached to each side of the separator 213. The electrodes can also be applied or coated on a metal substrate. Examples of materials that can be used as anode are zinc, aluminum, magnesium, tin and their alloys, and examples of cathode materials are copper, nickel, stainless steel and titanium. Examples of coated substrates include galvanized steel or tin-coated steel. Higher cell voltages may be obtained using manganese dioxide/carbon cathodes or cuprous chloride/carbon cathodes supported on stainless steel.

The separator 213 can be made from a woven or nonwoven fabric, paper, glass fiber or any other spongy, porous and water absorbing material. The separator contains salts 215—i.e., solid materials which, upon contact with water, dissolve to form ions. Such materials may be neutral, alkaline, or acidic substances. Non-limiting examples include ammonium chloride, sodium carbonate, citric acid, sodium chloride, and zinc chloride. The salt may be applied to its surfaces or absorbed in the separator 213.

The separator 213 is almost the size of the whole segment, so that when a fault happens in any part of the segment, the separator gets wet and activates the battery.

In order to prevent corrosion of the electrodes while the water activated battery is inactive, the salt 215 is applied to the separator—only around and away from the electrodes, so that no salts will be present in the piece of separator that lies between the two electrodes.

The separator is acting as the humidity detector, because as soon as the separator gets wet, the salt is dissolved to form an electrolytic solution. This electrolytic solution spreads along the separator 213 till it reaches its central part where the two electrodes 211 212 are located, and activates the battery. The power provided by the battery initiates the alerting process of the ADTMU.

FIG. 14 is an exemplary block diagram of the Electric Circuit E.C. An input point 231 from the battery to the electric circuit is shown. The input is connected to a capacitor 222 which accumulates and stores the electric energy and is connected to a voltage-controlled solenoid switch 223. Once the accumulated electricity reaches the capacitor's upper threshold with enough energy to power the transmission, the switch is turned on and the electric circuit is closed, connecting the capacitor to the transmitter 224. The transmitter begins at this stage to broadcast the alert signal through its antenna. As time passes the transmitter consumes electricity and the charge in the capacitor is reduced until it reaches its lower threshold. The switch then turns off, the circuit is broken, and the capacitor is disconnected from the transmitter, terminating the broadcast. The capacitor then begins to recharge, accumulating energy from the battery. This process is repeated, as long as the battery stays damp and for the span of the battery life.

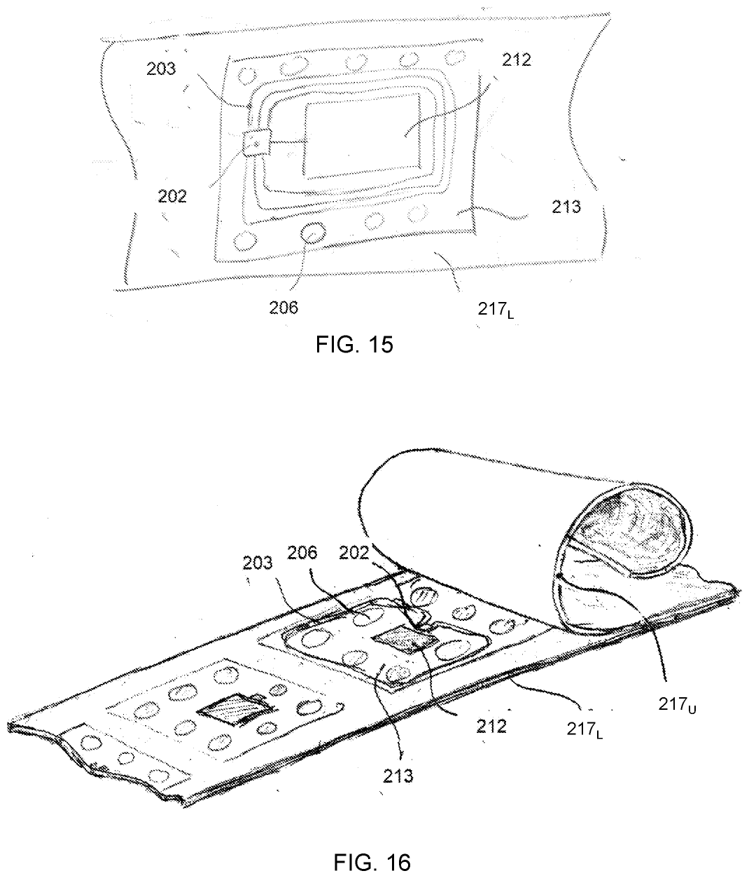

FIG. 15 is the ADTMU when imbedded within in a segment of Bitumen Smart Sealing Sheet.

Each segment in the Bitumen Smart Sealing Sheet is enveloped between bitumen layers 217. The ADTMU units are wrapped and sealed between the bitumen layers. There may be openings 206 in the separator 213 to allow for effective welding of the two bitumen layers enveloping the ADTMU.

The anode is beneath the separator 213 not seen in this view. The cathode 212, the electric circuit 202 and the antenna 203, are above the separator. The electric circuit 202 and the antenna 203 are waterproof—sealed, so that in case of a fault, when the inner area inside the bitumen sheets gets wet, the electric circuit 202 and the antenna 203 remain dry.

A fault in the Smart Sealing Sheet causes the water to enter a section, whereupon the separator 213 becomes wet. The salts impregnated in the separator 213 are dissolved, creating an electrolytic solution which spreads to between the electrodes. As a result, the battery begins supplying electric power and feeds the electric circuit 202, which starts the process that ends up sending an alert about the fault and its location.

FIG. 16 is an isometric view of the ADTMU imbedded in the bitumen smart sealing sheet section. The bottom bitumen layer 217 is shown exposed; above bottom bitumen layer 217 are the two electrodes (only the upper electrode 212 is shown). Between the two electrodes, the salt impregnated separator layer 213 is spread. The separator is much wider and longer than the electrodes, its dimensions may be close to the dimensions of the Smart Sealing Sheet Section. The electrodes 211 and 212 are laid out on the two sides of the separator, with the separator between them as a buffer.

The electric circuit 202 may be sealed in a water-tight package, isolated from the separator and all its surroundings, so that electric circuit 202 stays dry when the separator gets damp.

An antenna 203 can be built of a thin conductor wound in several coils along the margin of the section, also insulated and waterproofed from its surroundings. The antenna's length and structure can be determined and adjusted according to the required range and frequency of the transmission.

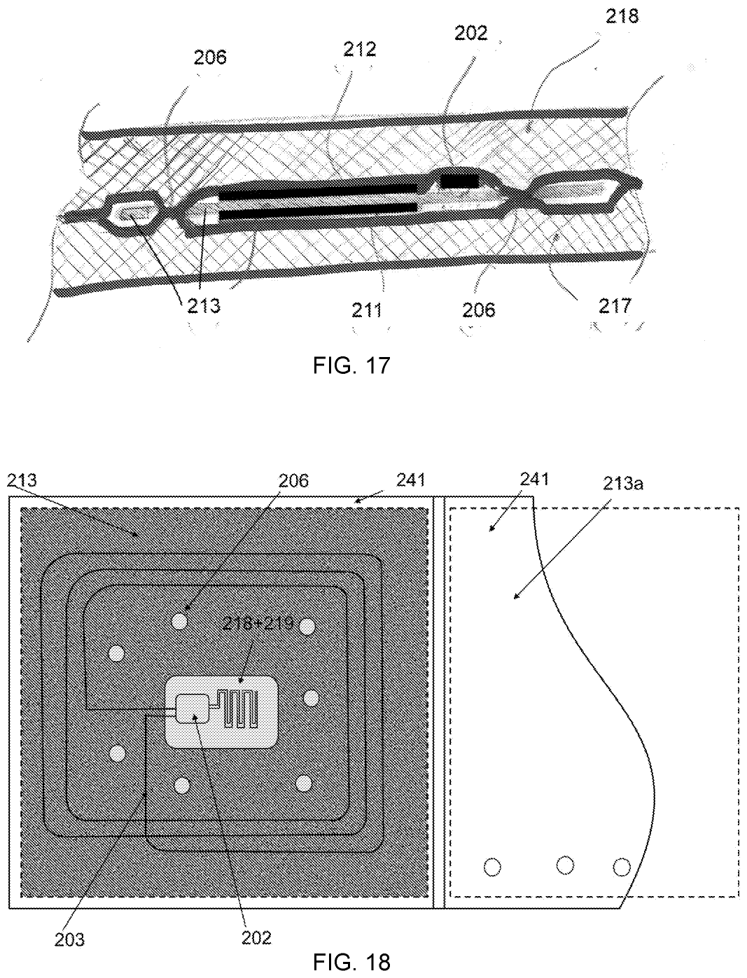

FIG. 17 is a cross section view of the ADTMU welded into the Smart Sealing Sheet. The upper and bottom bitumen layers of the Bitumen Smart Sealing Sheet 217_{U} and 217_{L}, envelope the ADTMU. The two electrodes 211 and 212 flanking the separator 213 are shown. In addition to the welding all around the separator there may be holes disposed in the separator 206 to allow efficient additional welding areas of the two bitumen layers.

FIG. 18 is a top view of an ADTMU in a membrane segment, where all the components including both the anode and cathode are located—on the same side of the separator. In order to improve the production process, an additional embodiment is shown in which all the components of the ADTMU are applied on the same side of the separator including both electrodes—the anode and cathode of the Water Activated Battery.

Instead of using two metal foils on both side of the separator, a pair of wires 218, 219, are applied to the upper side of the separator and connect, respectively, to the cathode and the anode. These two wires are made of two different metals, and can be laid close and parallel to each other, on the same side of the separator 213, e.g. in a sawtooth pattern.

The separator and all the components in the membrane segment are applied between two layers of bitumen sheets. The bottom layer sheet 241 is seen in this figure. The segment is sealed all around and thus sealed also from the neighbor segment 241a and the neighbor separator 213a. To improve the adhesion between the substrate membrane and its cover membrane that envelope the segment, some holes in the separator 206 may be added.

All the separator area is impregnated with salt except the area around the electrodes, so that no impregnated salt gets in touch with the electrodes 211, 212 as long as the separator remains dry. As soon as water penetrates the sealing, it reaches the separator, the salt then turns into an electrolytic solution, spreads into the area beneath the wires—the electrodes 211, 212, activating the battery. Then the battery activates the E.C. 202 and it starts transmitting through the antenna 203 that surrounds the inner part of the segment.

The fact that all the components, including both electrodes, are applied to one same side of the separator 213 may appreciably simplify the production and improve its reliability.

The E.C. as disclosed herein may have any or all of the following advantages:
Nondestructive wireless test of the Smart Sealing Sheet for checking perfection of the system after installation and allowing seasonal tests according to a maintenance plan.
Uniquely identifying the location of the faulty section, so that the information broadcasted by the control unit includes the exact location of the fault, without needing any scanning after getting the alarm.
Prevention of false alarms due to electronic interference in the area or receiving signals from other roofs.
Preventing lightning strikes.
Using a lower cost battery producing less voltage, embedding a more efficient circuit consuming less power.
Using frequencies which penetrate the coverage of the bitumen sealing.

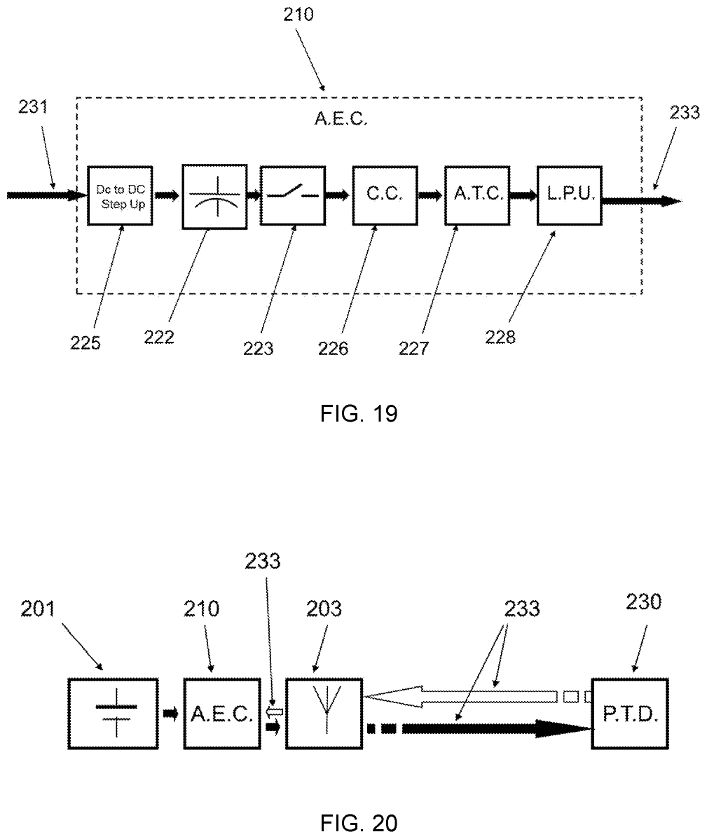

FIG. 19 is a sample block diagram of the Advanced Electric Circuit.

The input from the battery 231 is connected to a DC to DC step-up Power Converter 225 which increases the charge received from the battery and allows the circuit to work with lower voltage battery. The Power Converter 225 is connected to the Electric Capacitor 222, which in turn is connected through a Voltage Powered Solenoid Switch 223 to the control circuit 226.

The control circuit 226, is connected through an Antenna Termination Resistor Cap 227 which in turn is connected through a Lightning Protection Unit 228 to the antenna's combined output/input endpoint 233 as hereafter will be explained.

FIG. 20 is a block diagram of the Smart Sealing Sheet being tested with a Portable Testing Device for long term reliability. A Portable Testing Device P.T.D. 230 is used for checking the perfection of the system either after installation or to perform periodical test according to a maintenance plan to ensure its long-term reliability.

The test is aimed for both:

a Test the ability of the electronic system to alert.

b Test the “health” of the water activated battery.

A Portable Testing Device P.T.D. 230 is used as follows:

a To test the electronic system, the P.T.D 230 is equipped with a directional antenna and when testing, each section is pointed to, and is tested separately. It broadcasts a directional—low-divergence, signal to the antenna 203 through the antenna's combined output/input endpoint 233. The antenna transfers the energy received from the Portable Testing Device to energize the Advanced Electric Circuit 210 to turn it on as it would happen by the battery when activated by humidity. The same antenna 203 is used for both, receiving the energy needed to activate the Advanced Electric Circuit 210, and afterwards to transmit the test signal back to the P.T.D. 230.

b To test the “health” of the water activated battery without activating it. The P.T.D. 230 is equipped, with an impedance measurement unit of AC frequency of 1000 Hz, for example. An unwetted, non-activated battery of the type described above will have a characteristic high range of impedance, which will fall to lower values once the system is wetted and thereby activated. The exact impedance values will depend on the battery chemistry and construction but for a given system the values will be known. An impedance check will then confirm that the battery is in a non-activated “healthy” state, ready for being activated by wetness.

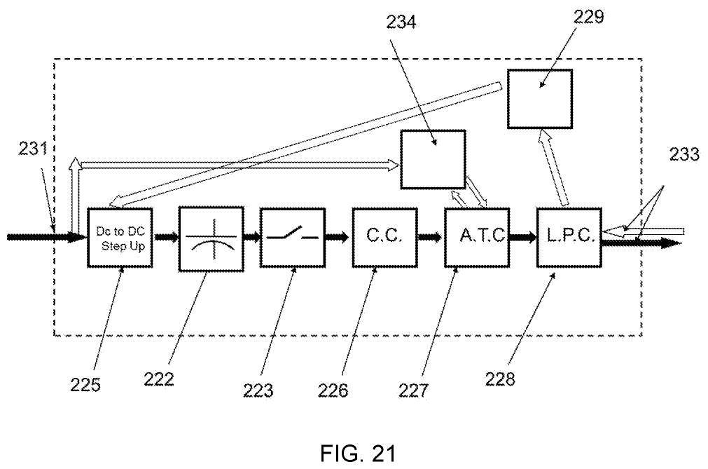

FIG. 21 is a block diagram of the Electric Circuit being tested. Energy from the P.T.D. enters through the combined antenna input/output point 233 into the Electric Surge and Lightning Protection Unit LPU 228, and then into the Remote Charging Circuit 229, from there into the DC to DC Step-up Power Converter 225, as it would be using the battery. From there it continues as a regular fault indication triggered by dampness, to the Electric Capacitor 222 for charging the capacitor with energy. This simulates the process which, in case of fault, would be triggered by dampness. The output signal is now transmitted back to the Portable Testing Device, where it is analyzed after receipt.

It should be understood by any person skilled in the art that when operating the Self-Test mode from the Portable Testing Device on each section of the sheet, with a directed transmission using a directed antenna, only the section being tested will be affected and the energy will not reach adjacent sections. To achieve this, the Portable Testing Device has a unidirectional antenna with the ability to adjust and fine tune initial transmission energy and amplitude. Thus, each section is tested separately one by one.

It will be apparent to a person skilled in the art that the process of accepting the test signal and initiating the self-test is separated in time from the process of emitting the return signal, such that the two do not interfere with one another.

The self-test may include testing the battery for its state of readiness by an impedance measurement. This can be done wirelessly using a test circuit 234 implemented into the electric circuit being connected to the battery. The results of the impedance measurement will be transmitted to the P.T.D. 230.

### A Numerical Example for the Electric Circuit

A low voltage output was produced from a battery having a working voltage of 0.7 V. The battery was made using two single electrodes from a copper (Cu) foil and a zinc (Zn) foil and an electrolyte solution based on table salt (NaCl). The Power Converter 225 charges the Capacitor 222, until its charge reaches the upper threshold of 1.9 volt. At this stage, the switch turns on, the circuit is closed, and the transmitter begins broadcasting, consuming electricity until the capacitor reaches its lower threshold of (for example, 0.9 volt).

For a 40 μf capacitor, the transmitter consumed only 23p, allowing the transmitter to broadcast a 20 ms. transmission with a 1.6 mA current to over 30 meters and more, even when the antenna is covered by tiles or submerged in damp gardening soil of 0.5-meter thickness, and covered by vegetation.

An alternative for conveyance of water from the leak point to the battery area might be simply via etched or marked out grooves in the sealing inner layers which encapsulate the ADTMU.

RFID Based System

The water activated battery embodiment can be combined with active RFID components with a transmission range of up to 100 meters.

By using the water/dampness activated power source and the DC to DC step-up Power Converter as the power supply to an active RFID device, this device operates at an ultrahigh frequency UHF band to achieve expanded range.

Several RFID devices can share one transmitting antenna as each device transmits a unique code.

The size/diameter of the transmitting antenna determines the range of detection.

The Control Unit includes, or consists of, an RFID fixed reader that receives the signal detects it and transfers it on the cellular, LAN or web network to a monitoring system, or to the consumer's smartphone or computer 205.

According to embodiments, a sealing membrane sheet comprises multiple segments in which each segment includes, or consists of, a humidity detector approaching the size of the whole segment, and sealed into each segment is a water activated battery and a wireless transmitter.

Unless otherwise defined herein, words and phrases used herein are to be understood in accordance with their usual meaning in normal usage. In the description and claims of the present disclosure, each of the verbs, “comprise”, “include” and “have”, and conjugates thereof, are used to indicate that the object or objects of the verb are not necessarily a complete listing of members, components, elements or parts of the subject or subjects of the verb. As used herein, the singular form “a”, “an” and “the” include plural references unless the context clearly dictates otherwise.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A water-impermeable membrane assembly for sealing the surface of a substrate, the assembly having leak alarm capabilities, the assembly comprising:
a. upper and lower water-impermeable membranes sealed to each other at their respective perimeters, so as to form a plenum that is enclosed from above and below by said membranes and that has a plenum area defined on all of its sides by the sealing at said perimeters;
b. a leak-alarm circuit disposed within the plenum and activatable by the presence of a water-containing liquid, the leak alarm circuit having a leak-alarm target operative to trigger activation of the leak-alarm circuit when in contact with a water-containing liquid, the leak-alarm circuit comprising:
i. an electronic circuit comprising a transmitter, the electronic circuit being operative, when in an activated state triggered by said leak-alarm target, to transmit a signal; and
ii. a battery connected to the electronic circuit for powering transmission of said signal; and
c. a capillary pathway disposed within the plenum and in contact with said leak-alarm target, so as to provide a pathway for transport of a water-containing liquid by capillary action to said leak-alarm target, wherein an area ratio of leak-alarm target footprint to said plenum area is less than 0.05.

2. The assembly of claim 1, wherein a footprint ratio of aggregate capillary pathway footprint to plenum area is at least 0.3.

3. The assembly of claim 2, wherein the footprint ratio is at least 0.5.

4. The assembly of claim 3, wherein the footprint ratio is at least 0.7.

5. The assembly of claim 4, wherein the footprint ratio is at least 0.9.

6. The assembly of any one of the preceding claims, with the plenum area virtually divided into 100 equal-area subdivisions, and wherein a continuous capillary pathway exists from at least 50% of said equal-area subdivisions to said leak-alarm target.

7. The assembly of claim 6, wherein a continuous capillary pathway exists from at least 70% of said equal-area subdivisions to said leak-alarm target.

8. The assembly of claim 7, wherein a continuous capillary pathway exists from at least 90% of said equal-area subdivisions to said leak-alarm target.

9. The assembly of any one of the preceding claims, wherein the leak-alarm target includes the battery and wherein the battery is a water-activated battery.

10. The assembly of claim 9, wherein a first portion of said capillary pathway is engaged with two electrodes of the water-activated battery, such that in the presence of water in said first portion sufficient to contact both of the two electrodes, a current-generating reaction takes place in the water-activated battery.

11. The assembly of claim 10, additionally comprising a salt disposed at a second portion of the capillary pathway that is exclusive of the first portion, wherein the current-generating reaction is facilitated by salt dissolved in the water-containing liquid and conveyed to the battery by said transport.

12. The assembly of any one of claims 1 to 8, wherein the electronic circuit comprises a water-detection circuit, and wherein the leak-alarm target is the water-detection circuit.

13. The assembly of any one of the preceding claims, wherein the leak-alarm circuit is configured to transmit information related to its status in response to being polled.

14. The assembly of any one of the preceding claims, wherein the leak-alarm circuit is configured to transmit information about the identity and/or location of the assembly in response to being polled.

15. The assembly of any one of the preceding claims, wherein the transmitted signal includes information about the identity and/or location of the assembly.

16. The assembly of any one of the preceding claims, additionally comprising a plurality of capillary-pathway extensions, said extensions passing through slits in the lower water-impermeable membrane and in contact with said capillary pathway within said plenum, so as to provide a pathway for transport of a water-containing liquid by capillary action from outside the plenum and below the lower water-impermeable membrane, to said leak-alarm target inside the plenum.

17. The assembly of any one of the preceding claims, wherein the capillary pathway comprises at least one of a plant-based fiber, a polymer-based fiber, a glass fiber and a carbon fiber.

18. The assembly of any one of the preceding claims, wherein the plenum area is at least 0.6 square meters, and optionally, at least 0.8 square meters.

19. The assembly of any one of the preceding claims, wherein said ratio of said leak-alarm target footprint to the plenum area is less than 0.025, and optionally, less than 0.01.

20. The assembly of any one of the preceding claims, wherein the upper and lower water-impermeable membranes are further bonded to each other at a plurality of points within the plenum.

21. The assembly of any one of the preceding claims, wherein at least one membrane of the upper and lower water-impermeable membranes is characterized by grooves and/or channels in a respective plenum-facing surface, and wherein the capillary pathway is disposed in at least some of said grooves and/or channels.

22. A super-assembly comprising a plurality of water-impermeable membrane assemblies as claimed in any one of the preceding claims, the assemblies being arranged in a continuous strip.

23. A method of sealing a substrate using a plurality of leak-detecting membrane assemblies, the method comprising:
(a) providing a plurality of water-impermeable membrane assemblies; and
(b) bonding, to the substrate, said plurality of water-impermeable membrane assemblies, each assembly comprising:
i. upper and lower water-impermeable membranes sealed to each other at their respective perimeters, so as to form a plenum that is enclosed from above and below by said membranes and that has an area defined on all of its sides by the sealing at said perimeters;
ii. a leak-alarm circuit disposed within the plenum and activatable by the presence of a water-containing liquid, the leak alarm circuit having a leak-alarm target operative to trigger activation of the leak-alarm circuit when in contact with a water-containing liquid, wherein an area ratio of leak-alarm target footprint to said plenum area is less than 0.05, the leak-alarm circuit comprising:
A. an electronic circuit comprising a transmitter, the electronic circuit being operative, when in an activated state triggered by said leak-alarm target, to transmit a signal; and
B. a battery connected to the electronic circuit for powering transmission of said signal; and
iii. a capillary pathway disposed within the plenum and in contact with said leak-alarm target, so as to provide a pathway for transport of a water-containing liquid by capillary action to said leak-alarm target.

24. The method of claim 23, additionally comprising, before said bonding, applying a primer to said substrate.

25. The method of either one of claim 23 or 24, additionally comprising, after said bonding, polling said leak-alarm circuit and, in response to said polling, receiving information transmitted by said leak-alarm circuit, the information being related to a status of said leak-alarm circuit.
